(19) United States
(12) Patent Application Publication
(10) Pub. No.: US 2011/0002126 A1
(43) Pub. Date: Jan. 6, 2011

(54) Lens

(75) Inventors: Tien-Pao Chen, Chu-Nan (TW); Jyh-Der Hwang, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTERGRATED TECHNOLOGY, INC., Chu-Nan (TW)

(21) Appl. No.: 12/800,654

(22) Filed: May 20, 2010

(30) Foreign Application Priority Data
Jul. 6, 2009 (CN) 200910304051.2

(51) Int. Cl. F21V 7/00; F21V 5/04; F21V 5/00

(52) U.S. Cl. 362/296.01; 362/335; 362/327

(57) ABSTRACT

A lens for a LED light source includes a first light emitting surface and a light incident surface perpendicular to the optical axis of the lens. The first light emitting surface is a convex surface and opposite to the light incident surface. The lens further includes a second light emitting surface opposite to the light incident surface and adjacent to the first light emitting surface. The thickness between the second light emitting surface and the light incident surface near the optical axis exceeds the thickness between the second light emitting surface and the light incident surface away from the optical axis.

### BACKGROUND

1. Technical Field

The disclosure relates to a lens, and particularly to a lens for light emitting diodes.

2. Description of the Related Art

Light emitting diodes' (LEDs) many advantages, such as high luminosity, low operational voltage, low power consumption, compatibility with integrated circuits, easy driving, long term reliability, and environmental friendliness, have promoted their wide use as a light source. Now, light emitting diodes are commonly applied in lighting.

Danial A. Steigerwald et al in IEEE Journal on Selected Topics in Quantum Electronics, Vol. 8, No. 2, March/April 2002, “Illumination with Solid State Lighting Technology” characterize new type light emitting diodes.

LED is a point light source and the divergence angle of light is larger. When provided for long-distance illumination, a focus lens is generally required at the front of the LED light source to reduce the divergence angle and focus light near the optical axis. As shown in FIG. 1, a general convex lens 10 can act as focus lens of a LED light source 11. The LED light source 11 is positioned on the focus of the convex lens 10. The light 110 from the LED passes through the lens and is emitted in focus.

Referring to FIG. 2, China patent (200710091159.9) discloses an improved focus lens. The improved focus lens includes a transparent body 20, a first lens portion 200 inside the transparent body 20, and a second lens portion 210 covering the first lens portion 200. The first lens portion 200 includes a first aspherical lens surface 23 and a second aspherical lens surface 24. The second lens portion 210 includes a light incident surface 25, a light reflection surface 26 and a light emitting surface 27. The light incident surface 25 surrounds the LED light source 12. The light reflection surface 26, a protruding curved surface, obliquely extends from the light incident surface 25 to the second aspherical lens surface 24. The light emitting surface 27 having a recession surface extends and inclines from the light reflection surface 26 to the second aspherical lens surface 24. With this lens type, light from the LED light source 12 at a wide angle can experience total reflection at the light reflection surface 26 of the lens to be emitted along the optical axis of the lens.

The LED light source using a focus lens or improved focus lens forms a continuous illumination area. In some situations, long distance and short distance focus may be desirable.

What is needed therefore, is a focus lens to overcome the described limitations.

### BRIEF DESCRIPTION OF THE DRAWINGS

Many aspects of the present illumination apparatus can be better understood with reference to the following drawings. The components in the drawings are not necessarily drawn to scale, the emphasis instead being placed upon clearly illustrating the principles of the present illumination device. Moreover, in the drawing, like reference numerals designate corresponding parts throughout the several views.

FIG. 1 is a schematic view of optical distribution of a LED light source using a convex lens as focus lens, in accordance with prior art.

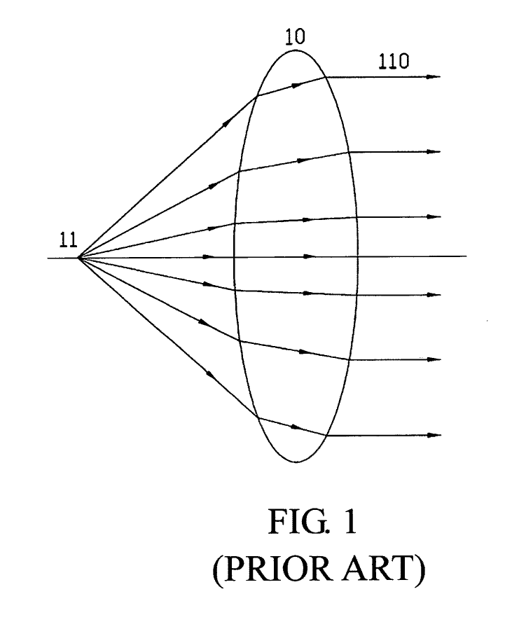

FIG. 2 is a schematic view of an improved focus lens, in accordance with China patent (200710091159.9).

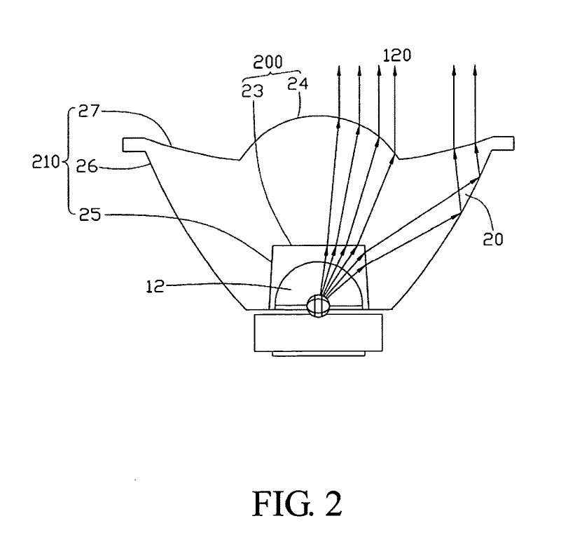

FIG. 3 is a schematic view of a first embodiment of a lens as disclosed.

FIG. 4 is a schematic view of optical distribution of the lens of FIG. 3.

FIG. 5 is a schematic view of far-field illumination distribution of light from the light source passing through the lens of FIG. 3.

FIG. 6 is a schematic view of near-field illumination distribution of light from the light source passing through the lens of FIG. 3.

FIG. 7 is a schematic view of optical distribution of a second embodiment of a lens.

FIG. 8 is a schematic view of far-field illumination distribution of light from the light source passing through the lens of FIG. 7.

FIG. 9 is a schematic view of near-field illumination distribution of light from the light source passing through the lens of FIG. 7.

FIG. 10 is a schematic view of optical distribution of a third embodiment of a lens.

FIG. 11 is a schematic view of far-field illumination distribution of light from the light source passing through the lens of FIG. 10.

FIG. 12 is a schematic view of near-field illumination distribution of light from the light source passing through the lens of FIG. 10.

FIG. 13 is a schematic view of optical distribution of a fourth embodiment of a lens.

FIG. 14 is a schematic view of far-field illumination distribution of light from the light source passing through the lens of FIG. 13.

FIG. 15 is a schematic view of near-field illumination distribution of light from the light source passing through the lens of FIG. 13.

### DETAILED DESCRIPTION

Embodiments of a lens are described in detail here with reference to the drawings.

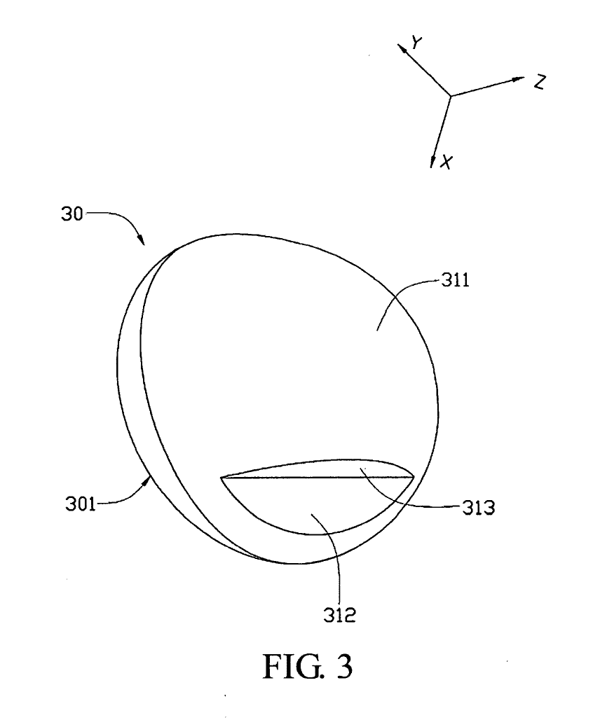

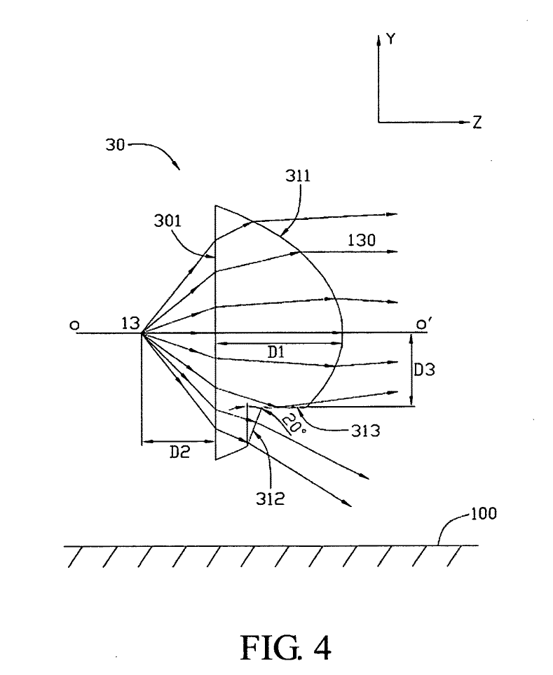

Referring to FIG. 3 and FIG. 4, an axis Z is substantially parallel to the optical axis OO′ of a lens 30, the axis Y is substantially perpendicular to the horizon and the axis Z, and the axis X is substantially perpendicular to the plane formed by the axis Y and the axis Z.

The lens 30 in accordance with a first embodiment includes a light incident surface 301, a first light emitting surface 311, a second light emitting surface 312, and a light reflecting surface 313. The light incident surface 301 is substantially perpendicular to the optical axis OO′ of the lens 30. The first light emitting surface 311 is a convex surface on the top portion of the lens 30. The second light emitting surface 312 is on the bottom portion of the lens 30.

The light incident surface 301, a plane, is on one end near the LED light source 13. The LED light source 13 is mounted on the optical axis OO′ of the lens 30. The light 130 from the LED light source 13 passes through the light incident surface 301 and enters the lens 30.

The first light emitting surface 311 is a convex surface converging light 130 from the LED light source 13. In this embodiment, the projection of the first light emitting surface 311 on the plane XZ, the horizontal plane, is an arc, elliptical arc, parabolic curve, or formula curve of order equaling or exceeding two and the projection on the plane YZ, the vertical plane, is an arc, elliptical arc, parabolic curve, or formula curve of order equaling or exceeding two.

According to the difference of the illumination distribution of the illumination area, the first light emitting surface 311 can be an axis symmetric curve surface or an axis non-symmetric curve surface, as long as the focus length of the axis Y is about 3 mm to about 25 mm and of the axis X is about 1.0 to about 1.3 times the focus length of the axis Y.

In this embodiment, the first light emitting surface 311 fits a Formula 1 of:

$$z = \frac{{c}_{x} {x}^{2} + {c}_{y} {y}^{2}}{1 + \sqrt{1 - ( 1 + {k}_{x} ) {c}_{x}^{2} {x}^{2} - ( 1 + {k}_{y} ) {c}_{y}^{2} {y}^{2}}}$$

Here, the intersection point of the first light emitting surface 311 of the lens 30 and the optical axis OO′ is defined as the origin of the coordinates. cₓ, c_{y}, kₓ, and k_{y} are constants. In this embodiment, cₓ is equal to about −0.156366, c_{y} is equal to about −0.181305, kₓ is equal to about −0.83540528, and k_{y} is about −0.7169062.

cₓ, c_{y}, kₓ, and k_{y} can be different values according to different illumination distribution as long as the focus length of the axis Y is about 3 mm to about 25 mm and focus length of the axis X is about 1.0 to about 1.3 times the focus length of the axis Y.

The thickness between the second light emitting surface 312 and the light incident surface 301 near the optical axis OO′ of the lens 30 exceeds that between the second light emitting surface 312 and the light incident surface 301 away from the optical axis OO′ of the lens 30.

The second light emitting surface 312 can be a plane, and the included angle between the second light emitting surface 312 and the light incident surface 301 is about 15° to about 45°. In this embodiment, the included angle between the second light emitting surface 312, which can be a plane, and the light incident surface 301 is about 20°. Alternatively, the second light emitting surface 312 can be a spherical surface with radius of curvature exceeding about 50 mm according to the differences of illumination area.

The range of the width d of the second light emitting surface 312 on the axis Y is 0<d≦Φ/2, where the Φ is the total width of the lens 30 on the axis Y.

The light reflecting surface 313, a plane, is located between the first light emitting surface 311 and the second light emitting surface 312. The light reflecting surface 313 can be substantially parallel to the optical axis OO′ of the lens 30 or also can form a specific angle with the optical axis OO′ of the lens 30 between about 0° and about 10°. In this embodiment, the light reflecting surface 313 is substantially parallel to the optical axis OO′ of the lens 30.

Moreover, to enhance reflection, a metal reflection layer can be coated on the light reflecting surface 313.

Since the first light emitting surface 311 can be a convex surface with larger radian, the first light emitting surface 311 is directly adjacent to the second light emitting surface 312 and forms a different illumination area.

The lens 30 can be PC (polycarbonate), PMMA (polymethyl methacrylate), silicone, resin, optical glass or other optical lens material. In this embodiment, the lens 30 is PC (polycarbonate).

The light 130 from the LED light source 13 enters the lens 30 and experiences refraction at the light incidence surface 301, and then respectively enters the first light emitting surface 311, the second light emitting surface 312, and the light reflecting surface 313. Since the first light emitting surface 311 is a convex surface, the light from the first light emitting surface 311 converges to the optical axis OO′ of the lens 30 and forms a far optical field and provides the illumination of the far regions. Since the thickness between the second light emitting surface 312 and the light incident surface 301 near the optical axis OO′ of the lens 30 exceeds the thickness between the second light emitting surface 312 and the light incident surface 301 away from the optical axis OO′ of the lens 30, the light 130 passing through the second light emitting surface 312 is deflected away from optical axis OO′, and then forms the near optical field and provides the illumination of the ground surface 100. Since the light reflecting surface 313 is almost parallel or exactly parallel to the optical axis OO′ of the lens 30, most of the light 130 incident to the light reflecting surface 313 experiences total reflection, passing through the first light emitting surface 311 to provide the far optical field.

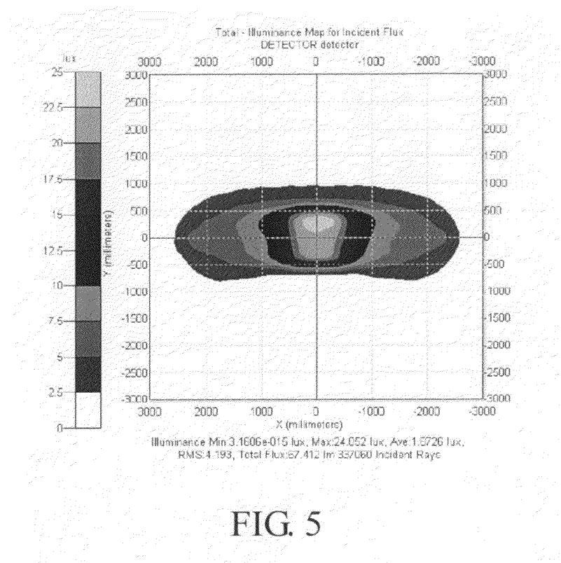

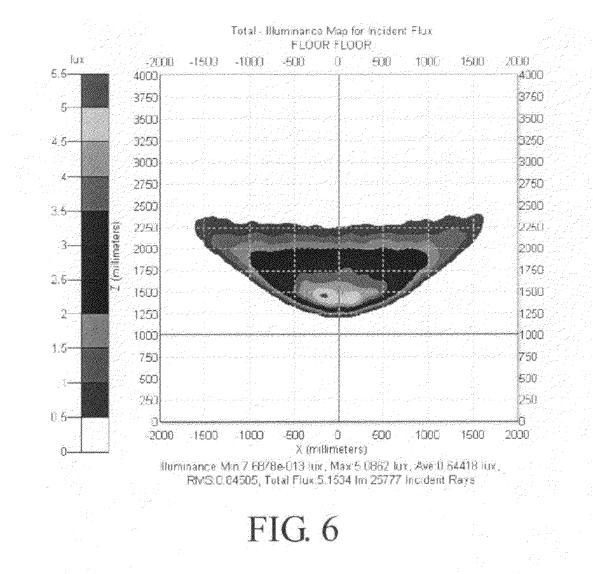

In this embodiment, at maximum thickness D1 of the lens 30, the furthest distance from the first light emitting surface 311 to the light incident surface 301 is about 9.5 mm. The distance D2 from the LED light source 13 to the light incident surface 301 of the lens 30 is about 4 mm. The distance D3 from the light reflecting surface 313 to the optical axis OO′ is about 5.4 mm. The farthest distance between an object (not shown) to be illuminated by the LED light source 13 and the lens 30 is about 10 m. The distance between the optical axis OO′ and the ground surface 100 is about 1 m. Referring to FIG. 5, the light 130 from the LED light source 13 passing through the lens 30 in the FIG. 3 is emitted and provides a far optical field approximately rectangular. Referring to FIG. 6, the light 130 from the LED light source 13 passing through the lens 30 of the first embodiment also forms a brighter near optical field on the ground surface 100. Preferably but not limited thereto, the lens 30 and the LED light source 13 are used in a bicycle head light (not shown), wherein the light LED light source 13 can illuminate simultaneously a distant object in front of the bicycle and the ground.

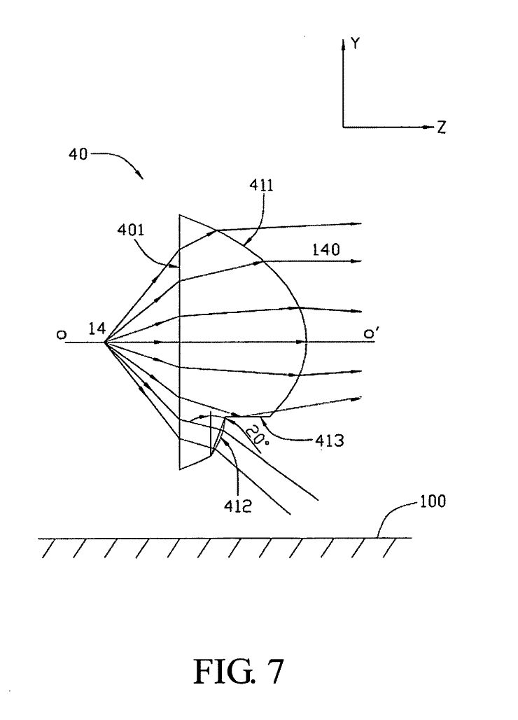

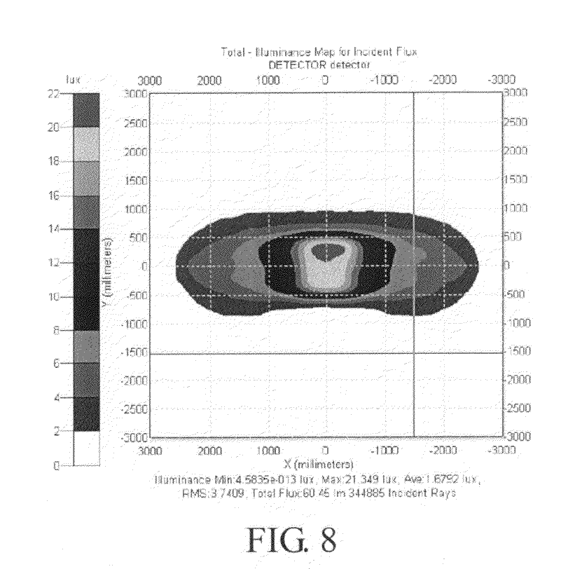

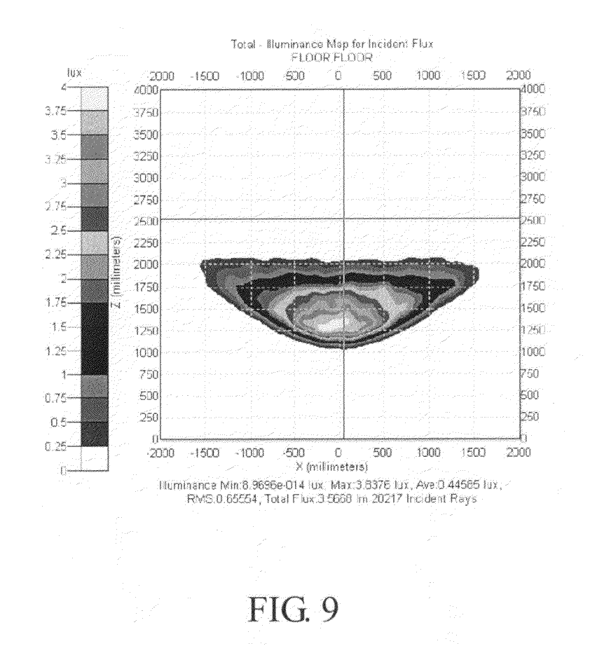

Referring to FIG. 7, a lens 40 in accordance with a second embodiment differs from the first embodiment only in that the second light emitting surface 412 is spherical with about 50 mm radius of curvature. The included angle between the sag of the projection of the spherical surface on the plane YZ and the light incident plane 401 is about 15° to about 45°. In this embodiment, the included angle between the sag of the projection of the spherical surface on the plane YZ and the light incident plane 401 is about 20°. The light 140 passing through the first light emitting surface 411 provides the far optical field and passing through the second light emitting surface 412 provides the near optical field. The far-field illumination distribution is shown in FIG. 8 and the near-field illumination distribution is shown in FIG. 9.

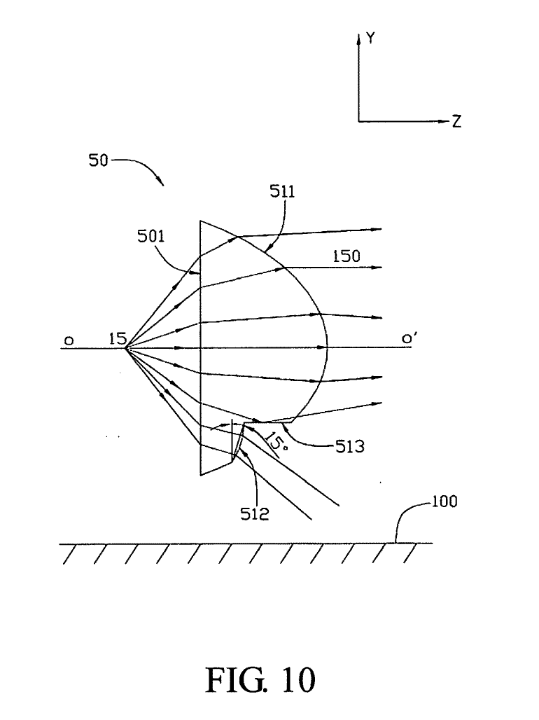

Referring to FIG. 10, a lens 50 in accordance with a third embodiment differs from the lens 40 of the second embodiment only in that the included angle between the sag of the projection of the spherical surface on the plane YZ and the light incident surface 501 is about 15°.

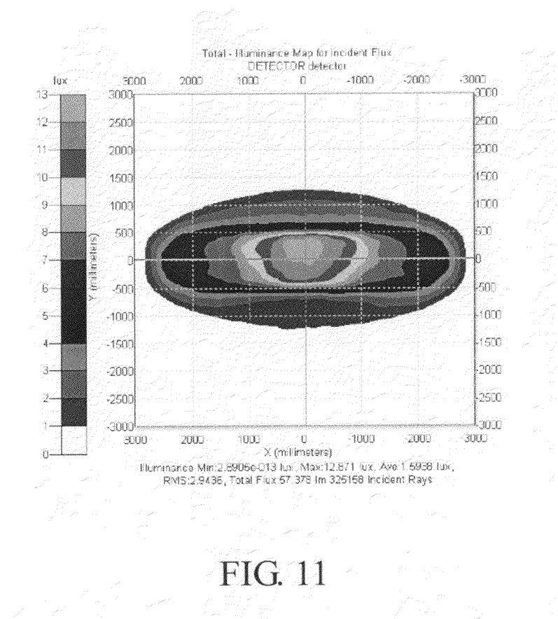

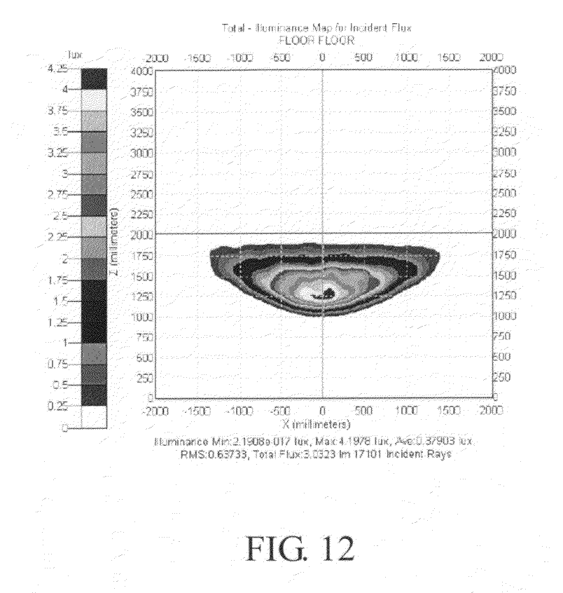

The light 150 passing through the first light emitting surface 511 provides the far optical field and passing through the second light emitting surface 512 provides the near optical field on the ground surface 100. The far-field illumination distribution is shown in FIG. 11 and the near-field illumination distribution is shown in FIG. 12.

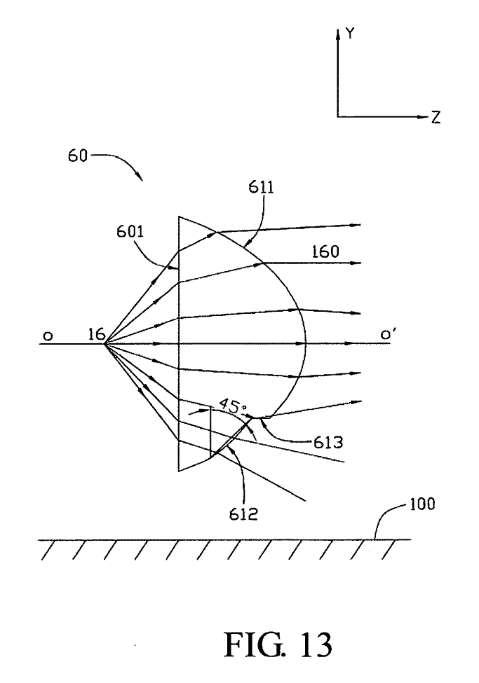

Referring to FIG. 13, a lens 60 in accordance with a fourth embodiment differs from the lens 40 of the second embodiment only in that the included angle between the sag of the projection of the spherical surface on the plane YZ to the light incident surface 601 is about 45°.

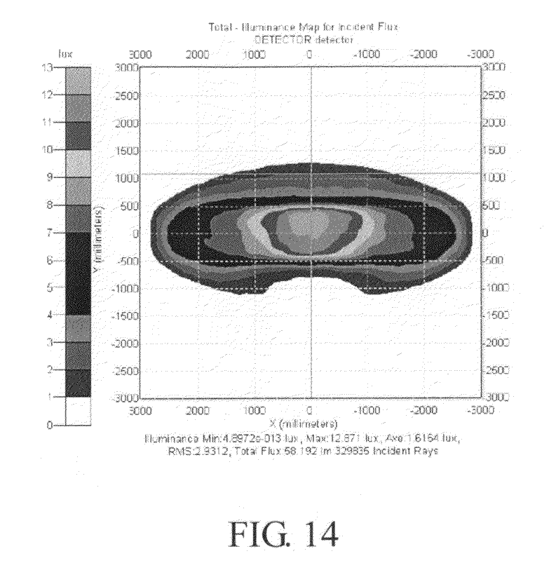

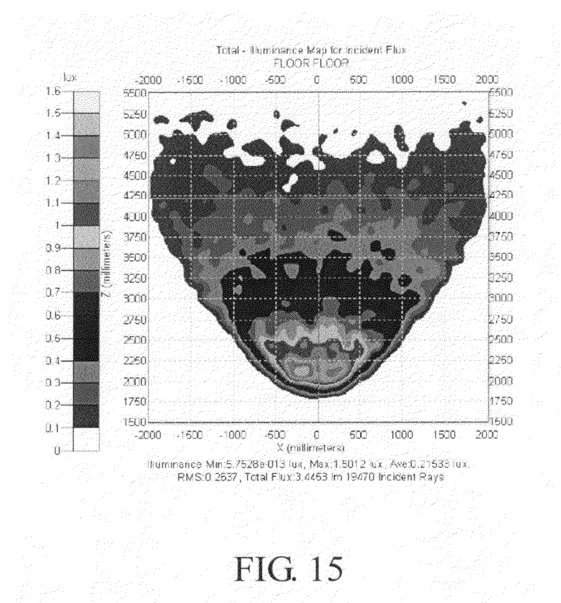

The light 160 passing through the first light emitting surface 611 provides the far optical field and passing through the second light emitting surface 612 provides the near optical field on the ground surface 100. The far-field illumination distribution is shown in FIG. 14 and the near-field illumination distribution is shown in FIG. 15.

While certain embodiments have been described and exemplified, various other embodiments from the foregoing disclosure will be apparent to these skilled in the art. The disclosure is not limited to the particular embodiments described and exemplified but is capable of considerable variation and modification without departure from the scope of the appended claims.

What is claimed is:

1. A lens comprising a light incident surface and a first light emitting surface, the light incident surface is substantially perpendicular to an optical axis of the lens, the first light emitting surface is a convex surface and opposite to the light incident surface, wherein the lens further includes a second light emitting surface opposite to the light incident surface and adjacent to the first light emitting surface, and the thickness between the second light emitting surface and the light incident surface near the optical axis of the lens exceeds that between the second light emitting surface and the light incident surface away from the optical axis of the lens.

2. The lens of claim 1, wherein the projection of the first light emitting surface on the plane XZ, the horizontal plane, is an arc, elliptical arc, parabolic curve, or formula curve of order equaling or exceeding two; the projection on the plane YZ, the vertical plane, is an arc, elliptical arc, parabolic curve, or formula curve of order equaling or exceeding two; and the axis Z is substantially parallel to the optical axis of the lens, the axis Y is substantially perpendicular to the horizontal plane, and the axis X is substantially perpendicular to the plane formed by the axes Y and Z.

3. The lens of claim 2, wherein the focus length of the first light emitting surface on the axis X exceeds that on the axis Y, the focus length range of the axis Y is between about 3 mm to about 25 mm, and the focus length range of the axis X is about 1.0 to about 1.3 times of that on the axis Y.

4. The lens of claim 2, wherein the range of width d of the second light emitting surface on the axis Y is 0<d≦Φ/2, Φ is the total width of the lens on axis Y, and the axis Y is substantially perpendicular to the horizontal plane.

5. The lens of claim 1, wherein the second light emitting surface is a plane, and the included angle between the second light emitting surface and the light incident plane is about 15° to about 45°.

6. The lens of claim 1, wherein the second light emitting surface is a spherical surface having radius of curvature exceeding about 50 mm, the included angle between the sag of projection of the spherical surface on the plane YZ and the light incident plane is about 15° to about 45°, the axis Z is substantially parallel to the optical axis of the lens, and the axis Y is substantially perpendicular to the horizontal plane.

7. The lens of claim 1 further comprising a light reflecting surface located between the first light emitting surface and the second light emitting surface, and the light reflecting surface extends along the optical axis of the lens.

8. The lens of claim 7, wherein the light reflecting surface is a plane, and the included angle between the light reflecting surface and the optical axis of the lens is about 0° to about 10°.

9. The lens of claim 7, wherein a metal reflection layer is provided on the light reflecting surface.

10. The lens of claim 1, wherein the lens is PC (polycarbonate), PMMA (polymethyl methacrylate), silicone, resin, optical glass or other optical lens material.

11. A LED light combination comprising:
a LED light source; and
a lens located in front of the LED light source for modulating light generated by the LED light source and extending through the lens, the lens comprising a light incident surface adjacent to the LED light source and first and second light emitting surfaces and a light reflecting surface away from the LED light source, the light incident surface is substantially perpendicular to an optical axis of the lens, the light reflecting surface being located between the first and second light emitting surfaces and reflecting light from the LED light source and incident thereon to the first light emitting surface, the second light emitting surface being located below the first light emitting surface and facing inclinedly downwardly to refract the light from the LED light source and incident thereon to an object below and in front of the lens, and the first light emitting surface refracting the light from the LED light source and incident thereon forwardly toward the optical axis of the lens.

12. The LED light combination of claim 11, wherein an included angle between the second light emitting surface and the light incident surface is between about 15° and about 45°.

13. The LED light combination of claim 11, wherein the second light emitting surface is one of a planar surface and an arced surface.
